(19) United States
(12) Patent Application Publication
(10) Pub. No.: US 2005/0111627 A1
(43) Pub. Date: May 26, 2005

(54) Method of shielding scattered radiation in front of a detector array

(76) Inventor: Juergen Leppert, Forchheim (DE)

Correspondence Address: HARNESS, DICKEY & PIERCE, P.L.C., P.O.BOX 8910, RESTON, VA, 20195, US

(21) Appl. No.: 10/991,551

(22) Filed: Nov. 19, 2004

(30) Foreign Application Priority Data
Nov. 21, 2003 (DE) 10354808.4

(51) Int. Cl. G21K 1/00; G01J 5/02

(52) U.S. Cl. 378/154

(57) ABSTRACT

A method is for shielding scattered radiation in front of a detector array including a plurality of detector elements. A scattered radiation grating, which is assembled from slat-like absorption elements for the scattered radiation, in particular for x-rays, which are separated from one another by a filler and carrier material and which run approximately parallel to one another, is arranged in front of the detector array. The scattered radiation grating is one in which the absorption elements are located so close beside one another that an average spacing of the absorption elements is smaller at least by the factor 2 than a center spacing of the detector elements of the detector array. The method permits the use of a scattered radiation grating that can be produced economically.

The present application hereby claims priority under 35 U.S.C. §119 on German patent application number DE 103 54 808.4 filed Nov. 21, 2003, the entire contents of which are hereby incorporated herein by reference.

### FIELD OF THE INVENTION

The present invention generally relates to a method of shielding scattered radiation in front of a detector array including a plurality of detector elements. In particular, the method is for medical x-ray equipment. Further, it may be for a scattered radiation grating, which is assembled from slat-like absorption elements for the scattered radiation, in particular for x-rays, which are separated from one another by a filler and carrier material and which run approximately parallel to one another, is arranged in front of the detector array.

### BACKGROUND OF THE INVENTION

In typical areas of use of x-ray examination methods, such as x-ray inspection or medical x-ray diagnostics, the resolution that can be achieved during the radioscopy plays an important role. Good resolution is achieved when use is made of detector arrays having small-area detector elements located as close as possible beside one another and also a device arranged in front of these detector elements for the close limitation of the spatial angle at which the x-rays can fall onto the respective detector element.

In the ideal case, this device, known as a scattered radiation grating, allows only the x-rays propagating on a rectilinear connection between the focus of the x-ray tube used and the respective detector element to pass and absorbs x-rays which are incident at a different angle on account of scattering. The scattered radiation does not contribute to the image information, on account of its production history, and leads to considerable impairment of the signal to noise ratio and the achievable resolution of the x-ray image if it falls on the detector elements in an unattenuated form.

By way of using suitable scattered radiation gratings which, as a rule, are matched to the geometric conditions of the respective x-ray system, in particular the arrangement of the x-ray tube and x-ray detectors, the proportion of scattered radiation which reaches the detector elements can be reduced considerably, so that in many cases, x-ray images which can be evaluated for the first time are therefore obtained.

Scattered radiation gratings are assembled from numerous absorption elements for x-rays which are separated from one another by a filler and carrier material and which are either all aligned in the same direction at right angles to the surface of the scattered radiation grating or aligned with a common focus, the focus of the x-ray tube. Nowadays, in x-ray CT systems, as a rule scattered radiation gratings are still used whose absorption elements are formed of lead slats running approximately parallel to one another, between which paper strips are introduced as filler and carrier material.

In many cases, the spacing of the lead slats is set during the fabrication of the scattered radiation gratings, such that the lead slats lie as accurately as possible over the dividing septa of the detector-side fluorescent material array when the scattered radiation grating is used. The scattered radiation gratings therefore have to be produced mechanically very precisely. As a result of these high requirements on the precision, the fabrication of the scattered radiation gratings gives rise to high costs.

DE 197 26 846 C1 discloses a scattered radiation grating in which the spacing of the absorption elements, which are likewise slat-like here and are aligned parallel to one another, increases continuously from the center of the grating toward the edge. At the same time, the width of the absorption elements is increased toward the edge. By way of this configuration of the scattered radiation grating, it is possible to implement an absorption response which is largely uniform over the entire grating width. However, here, too, there are high requirements on the precision of the fabrication.

DE 199 20 301 C2 discloses a further scattered radiation grating in which the absorption elements extend substantially radially in spaced rows with respect to a center. The course and the arrangement of the absorption elements in this scattered radiation grating are predefined in accordance with a specific stipulation. In this case, silicon is used as a carrier material, into which holes are etched in accordance with the desired course of the rows of the absorption elements. Pin-like absorption elements made of lead are inserted into these holes. This scattered radiation grating also requires the maintenance of very high precision during fabrication which, in particular, is achieved by the fabrication technique proposed using silicon as carrier material.

U.S. Pat. No. 5,263,075 A describes a scattered radiation grating which permits two-dimensional collimation of the incident x-rays. The scattered radiation grating is produced from a glass fiber bundle, from which individual disk-like sections are sawn out. The cores of the individual glass fibers are etched out, so that capillary-like passage channels for the x-rays are produced. The glass material is then further doped with up to 60% lead in the form of lead oxide, so that enhanced x-ray absorption outside the passage channels is achieved. However, as a result of the etching and doping steps required in this case, the fabrication of this scattered radiation grating is also relatively complicated.

### SUMMARY OF THE INVENTION

An object of an embodiment of the present invention is to specify a method of shielding scattered radiation in front of a detector array which permits the use of a scattered radiation grating that can be produced economically.

In the present method of shielding scattered radiation in front of a detector array including a plurality of detector elements, in particular for medical x-ray equipment, a scattered radiation grating which is assembled from slat-like absorption elements for the scattered radiation, in particular for x-rays, which are separated from one another by a filler and carrier material and which run approximately parallel to one another, is arranged in a known manner in front of the detector array. The method is distinguished by the use of a scattered radiation grating in which the absorption elements are located so close beside one another that an average spacing of the absorption elements is smaller at least by the factor 2 than a center spacing of the detector elements of the detector array.

By selecting the small spacing of the slat-like absorption elements, this spacing no longer has to be matched to the grating dimension of the detector array during production. This permits substantially more economical production of such a scattered radiation grating since, during fabrication, neither highly precise alignment of the absorption elements nor any compliance with close tolerances is required. In the same way, when such a scattered radiation grating according to an embodiment of the present method is used, exact positioning over the detector array is no longer necessary.

When an embodiment of the present method of shielding scattered x-rays is used, the individual absorption elements include a material that absorbs x-rays highly, for example of a heavy metal such as lead, tungsten, tantalum or molybdenum. Other materials that absorb x-rays highly, such as plastics filled with lead powder, can also be used as materials for the absorption elements. On the other hand, the filler and carrier material should absorb the x-rays as little as possible. Examples of such materials are plastics such as polyethylene, polystyrene or polypropylene or else paper.

For the function of the scattered radiation grating used in the method, a filling level of the absorption elements, that is to say the proportion by volume of the absorption elements in the total volume of the scattered radiation grating, of 5 to 30% has proven to be advantageous since, with this value, adequate collimation is achieved without significant attenuation of the x-rays carrying the image information having to be accepted.

The scattered radiation grating itself can be constructed in the form of a plate, the absorption elements then substantially all being aligned in the same direction at right angles to the surface of the scattered radiation grating. However, a scattered radiation grating of this type, produced in the form of a flat plate, can also be mechanically deformed in such a way that it forms a plate bent approximately in the form of a spherical dome, in which the absorption elements are then at least approximately aligned with the center of the sphere which, when the scattered radiation grating is used, should coincide with the focus of the x-ray tube. A deformation of this type may readily be implemented in particular when plastics are used as the filler and carrier material.

The embodiments of the present method can be used above all for applications in which collimation of x-rays is required. The preferred area of application, however, resides in use in medical x-ray equipment, in particular in computer tomography.

The scattered radiation grating in the present method of an embodiment is merely placed on the detector array or fixed over the latter without any assignment to the individual detector elements or pixels of the detector array having to be taken into account. The effort on positioning is therefore dispensed with.

### BRIEF DESCRIPTION OF THE DRAWINGS

The present method will be explained once more by way of example in the following text by using an exemplary embodiment in conjunction with the figures, in which:

FIG. 1 shows an example of an arrangement including a scattered radiation grating and detector array according to an embodiment of the present method; and

FIG. 2 shows an enlarged illustration of the example of FIG. 1 in detail.

### DETAILED DESCRIPTION OF THE EXEMPLARY EMBODIMENTS

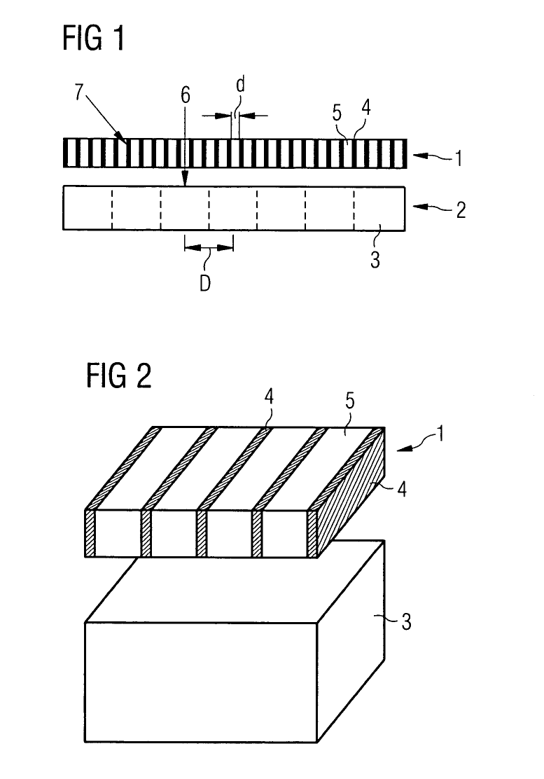

FIG. 1 shows an example of an arrangement including a scattered radiation grating 1 and detector array 2 according to an embodiment of the present method. The detector array 2 is assembled from a plurality of detector elements 3, which represent individual pixels for recording incident x-rays 6.

For the shielding of scattered radiation, according to an embodiment of the present method, use is made of a scattered radiation grating 1 whose slat-like absorption elements 4 have a spacing d which is smaller at least by the factor 2 than the center spacing D of the detector elements 3 of the detector array 2. This scattered radiation grating 1 is fixed over the detector array 2 in the present example, without having to position the former in a particular way relative to the inactive regions between the individual detector elements 3. In this case, the scattered radiation grating 1 permits x-rays 6 which are incident substantially at right angles to pass and absorbs scattered x-rays 7 which are incident at an oblique angle on account of scattering in the transilluminated object.

FIG. 2 reveals an enlarged detail of the scattered radiation grating 1 of FIG. 1 over a single detector element 3, the heights of the scattered radiation grating 1 and detector array 2 illustrated in FIGS. 1 and 2 not being reproduced to scale. In the case of this scattered radiation grating 1, the absorption elements 4 used are metal foils made of lead or tungsten, between which plastic films 5 are located as filler and carrier material, serving as spacers between the absorption elements 4. These plastic films 5 can include, for example, PE, PP or PET. They have a thickness between 1/10 and ⅕ of the pixel width of the detector elements 3 on which the scattered radiation grating 1 is used. During production, the plastic films 5 are adhesively bonded alternately to the thin metal foil which performs the absorption of the x-ray quanta, to form a stacked composite. This composite can then also be placed directly on the detector array 2 and bonded adhesively without any alignment with the pixel structure being necessary for this purpose.

A one-dimensional scattered radiation grating 1 of this type is suitable for single-line detector arrays or for detector arrays of a size which do not need any collimation in the other direction, in particular the z direction in CT systems.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of shielding scattered radiation in front of a detector array including a plurality of detector elements, the method comprising:
arranging a scattered radiation grating, assembled from slat-like absorption elements for the scattered radiation, which are separated from one another by a filler and carrier material and which run approximately parallel to one another, in front of the detector array, wherein the scattered radiation grating includes absorption elements located so close beside one another that an average spacing of the absorption elements is smaller at least by the factor 2 than a center spacing of the detector elements of the detector array.

2. The method as claimed in claim 1, wherein the scattered radiation grating includes absorption elements arranged with the same spacing from one another.

3. The method as claimed in claim 1, wherein the scattered radiation grating includes absorption elements of individual thin sheets of a material that absorb x-rays highly.

4. The method as claimed in claim 3, wherein the scattered radiation grating includes filler and carrier material formed by individual thin sheets of a material that is largely transparent to x-rays.

5. The method as claimed in claim 1, wherein the scattered radiation grating includes absorption elements having an extent in the spacing direction of at most ⅕ of the center spacing of the detector elements.

6. The method as claimed in claim 1, wherein the scattered radiation grating includes absorption elements and filler and carrier material present in the scattered radiation grating in a volume ratio which results in a filling level between 5% and 30% with the absorption elements.

7. The method as claimed in claim 1, wherein the scattered radiation grating includes absorption elements formed from a metallic material, and filler and carrier material that is a plastic material.

8. The method as claimed in claim 1, wherein the scattered radiation grating includes absorption elements formed from a metallic material, and filler and carrier material that is a paper material.

9. The method of claim 1, wherein the method is used for medical x-ray equipment.

10. The method of claim 1, wherein the scattered radiation grating is assembled from slat-like absorption elements for x-rays.

11. The method as claimed in claim 2, wherein the scattered radiation grating includes absorption elements of individual thin sheets of a material that absorb x-rays highly.

12. The method as claimed in claim 11, wherein the scattered radiation grating includes filler and carrier material formed by individual thin sheets of a material that is largely transparent to x-rays.

13. A scattered radiation grating, comprising:
a plurality of slat-like absorption elements, separated from one another by a filler and carrier material, wherein the plurality of slat-like absorption elements run approximately parallel to one another, and wherein the absorption elements located so close beside one another that an average spacing of the absorption elements is smaller at least by the factor 2 than a center spacing of detector elements of a detector array locateable behind the scattered radiation grating.

14. A system for shielding scattered radiation in front of a detector array including a plurality of detector elements, the system comprising:
a scattered radiation grating, including a plurality of slat-like absorption elements for the scattered radiation, which are separated from one another by a filler and carrier material and which run approximately parallel to one another, wherein the scattered radiation grating includes absorption elements located so close beside one another that an average spacing of the absorption elements is smaller at least by the factor 2 than a center spacing of the detector elements of the detector array.
